(19) United States
(12) Patent Application Publication
(10) Pub. No.: US 2015/0026481 A1
(43) Pub. Date: Jan. 22, 2015

(54) Computation Protected Against Spying

(71) Applicant: GIESECKE & DEVRIENT GMBH, Munich (DE)

(72) Inventor: Helmut Koglmeier, Munich (DE)

(21) Appl. No.: 14/382,026

(22) PCT Filed: Feb. 26, 2013
(86) PCT No.: PCT/EP2013/000559

§ 371 Date: Aug. 29, 2014

(30) Foreign Application Priority Data
Feb. 29, 2012 (DE) 10 2012 003 968.9

(51) Int. Cl. H04L 9/00; G06F 21/60; H04L 9/06

(52) U.S. Cl. CPC H04L 9/002; H04L 9/0625; G06F 21/60
USPC 713/189

(57) ABSTRACT

The invention provides a method for executing a cryptographic computation comprising a plurality of blocks while employing secret data in a processor, said executing being protected against spying out of secret data. To achieve a computational result of the computation, there is executed a multiple computation in which the computation is executed several times, at least twice. Within the multiple computation, blocks of the several, at least two, executions of the computation are executed in interlaced order.

This invention relates to a method for executing a multiply executed cryptographic computation while employing secret data, this being protected against spying out of the secret data.

Cryptographic computations are executed e.g. by general processors (CPUs), alternatively frequently by crypto-coprocessors, which are special processors associated with the general processors. In particular chip cards for funds transfer applications or mobile radio applications have processors with crypto-coprocessors. Secret data, e.g. keys, for a computation to be executed on the processor (general processor or crypto-coprocessor) are normally held in one or more registers associated with the processor, e.g. key registers.

Some processors, e.g. those with multitasking or multithreading ability, are able to operate several contexts during their operation, i.e. several mutually isolated runtime environments for program codes to be executed by the processor. Only one context is active at any time, the other contexts being in a waiting position. The program code in the currently active context is processed by the processor. The program codes in the non-active contexts are meanwhile deferred and executed only when the appurtenant context is activated. If a change is to be made from processing a program code in a first, currently active context to processing another program code in a second, currently non-active context, the processor switches from the first context to the second context. Typically, e.g. different applications, threads or tasks run in different contexts. Many processors, e.g. the ARM7 processor, moreover provide a user mode and system mode as mutually separate contexts.

In the most general case, a cryptographic computation processes input data into output data while employing secret data, e.g. a secret key, e.g. plain text data are encrypted into cipher data with a key, or cipher data conversely decrypted into plain text data with a key.

Many cryptographic computations can be subdivided into a plurality of blocks which form the computation in their totality. As blocks there can be provided in particular rounds of a cyclic method. Thus, for example the cryptographic computing method DES (Data Encryption Standard) comprises 16 rounds, with a portion of the input data being processed with a portion of the key in each round. However, there are also non-cyclic cryptographic methods in which each block constitutes a program code sequence.

Cryptographic computations process secret data, such as for example cryptographic keys, which are to remain secret. Nowadays there are sophisticated spy attacks with which the secret data can be spied out of an unprotected computation. In side channel attacks, e.g. the current consumption or the electromagnetic radiation of the processor executing the computation is measured and the secret data inferred therefrom. Masking the secret data offers a certain protection against this. In DFA attacks (DFA=Differential Fault Analysis), errors are injected into the processor in a targeted manner and the secret data inferred from the resultant disruption of the result of the computation. In combined spy attacks, a suitable time for a targeted disruption, e.g. DFA, is established via side channels such as e.g. current consumption or electromagnetic radiation, and the disruption carried out at this time. For example, significant features in the current consumption such as e.g. peaks can indicate suitable times for introducing a disruption.

As a countermeasure against spy attacks, security-critical computations of algorithms such as e.g. DES (Data Encryption Standard) are often executed twice or multiple times. The two or several computational results of the several executions are compared. If the suspicion of a disruption occurs upon one of the executions according to the comparison, the computational result is discarded. Where applicable, further measures are taken, such as for example disabling the processor or co-processor or the chip card, erasing memory areas, or the like.

Thus, EP 1 569 118 B1 describes a method for securely computing a result value E (e.g. a memory address) starting out from a parameter P (e.g. a base memory address), in which the result value is computed twice, the two result values are compared, and the result value is employed only in case of a satisfactory comparison result, and otherwise the computed result value is discarded as erroneous. In the two computations the parameter P is employed in one case and the complementary value ˜P of the parameter in the other case.

The multiple execution of one and the same computation enables a check of the computational result, but on the other hand increases an attacker's chances of success when tampering using e.g. DFA attacks, since he can attack the same computation in a targeted manner several times.

US-2009/0285398 A1 describes a method for verifying the integrity of a key of a symmetric cryptographic algorithm such as for example DES (Data Encryption Standard). Here, the algorithm is executed twice, once with a cryptographic key, and once with the ones' complement of the key. As a result, the two executions are no longer identical, thus reacting to tampering differently. Consequently, tampering is also recognized that involves for example tampering with the same key bit in the same manner upon each execution of the algorithm.

For a data carrier having an operating program with several operations, DE 198 22 218 A1 discloses measures for protecting the operating program against side channel attacks. Insofar as security-relevant operations occur, some operations in which the total result does not depend on the order of the computation are carried out in a changed order, for example in a randomly fixed order. The interchanging of the operations conceals from an attacker at what time which operation is carried out. Hence, a current profile can for example no longer be uniquely associated with an operation, so that it is not possible to select a certain operation for a targeted attack using the current profile.

The invention is based on the object of providing a method in which a cryptographic computation that is executed multiple times is protected against spying out of secret data.

This object is achieved by a method according to claim 1. Advantageous embodiments of the invention are stated in the dependent claims.

Claim 1 states a method for executing a cryptographic computation, said executing being protected against spying out of secret data. The computation comprises a plurality of blocks. Upon the computation, secret data are employed in order to generate a computational result; normally, output data representing the computational result are generated from input data and the secret data. The method is executed in a processor. To achieve the computational result of the computation, a multiple computation is executed, i.e. an algorithm forming the computation is executed several times, at least twice (or three times, four times, . . . ). This takes place in order that a verification of the computational result can subsequently be effected through comparison of the individual computational results of the several executions. Electively, such a verification of the computational result is carried out, as known, taken per se, from the prior art, through comparison of the computational results of the several executions and the computational result is employed or discarded depending on the result.

The method is characterized in that, within the multiple computation, blocks of the several executions—at least two executions—of the computation are executed in interlaced order. In other words, the order is not such that all blocks of one execution are processed first and the blocks of the other or next execution only processed subsequently, but rather a block of one execution and a block of another execution are executed in changing succession. For example, blocks (or at least one block) of a second execution are interspersed between the blocks of a first execution.

Through the interlacing of the blocks of different executions, a potential attacker no longer has two identical computations (executions) at his disposal in which he could look for times for attack in a targeted manner. Regarded from outside, the multiple computation comprising the several executions appears to be a chaotic succession of code blocks. This makes it very difficult or even impossible to find good times for disrupting the computation.

Hence, according to claim 1 there is provided a multiple computation of a cryptographic computation, said multiple computation being protected against spying out.

Electively, the succession of the blocks remains unchanged within each individual execution. As a result, the method is applicable even when successive blocks are mutually dependent, so that a subsequent block of an individual execution thus requires output data of at least one preceding block as input data. Different executions, however, are mutually independent and can hence be executed in an interlaced manner, i.e. with interspersing of blocks of a second (third, fourth, . . . ) execution between blocks of a first execution of the computation.

Electively, at least a first execution and a second execution of the computation are executed. In so doing, the blocks of the several, at least two, executions of the computation are executed in interlaced order to the effect that there is at least one block of the first execution that, in the succession, is executed before a block of the second execution, and there is at least one further block of the first execution that is executed after a block of the second execution.

Electively, the computation executed is a cyclic cryptographic computation with several rounds, for example DES (Data Encryption Standard). In this case, the blocks provided are rounds, e.g. 16 rounds in DES.

Electively, the computation provided is a non-cyclic cryptographic computation, the computation thus consisting of a succession of blocks that do not recur cyclically.

Electively, a new interlaced order is fixed for each multiple computation. Otherwise, an attacker could recognize patterns from the always identical interlacing and use them for attacks. Electively, the blocks are interlaced in a randomized manner.

Electively, each execution of the several executions of the computation that belong to an individual multiple computation is executed in a dedicated context of the processor. In so doing, the blocks of the several executions of the computation are executed in interlaced order by the processor (where applicable, optionally the general processor or the crypto-coprocessor) switching between the contexts in accordance with the interlaced order. Thus, if a block of a first execution is to be processed in a first context, the first context is active. If a block for a second execution is to be subsequently processed in a second, currently inactive context, the processor switches from the first context to the second context, so that now the first context is no longer active but rather the second context, and the block of the second execution is processed on the processor.

Electively, there is provided as a first context a user mode of the processor and as a second context a system mode thereof, or vice versa. Electively, the processor is a processor in which such a user mode and system mode are provided as mutually separate contexts, such as e.g. the ARM7 processor.

Electively, there are executed more than two (three, four, five, six, . . . ) executions of the computation in more than two (three, four, five, six, . . . ) contexts, and the interlacing is effectuated by switching between these more than two contexts (in particular in a randomized manner).

Electively, the processor switches between the contexts through a randomized time interval interrupt routine (timer interrupt) which respectively assigns to each context a time interval with a randomized length of computing time on the processor and then switches to another context.

Electively, the secret data for computations to be executed in different contexts are held in different registers of the processor. As a result, the processor respectively accesses different registers when processing program code for executions in different contexts. A physical disruption attack always occurring spatially at the same place on the chip of the processor thus hits e.g. a utilized register in a first context, but a non-employed register in another, second context. Therefore, the attack is ineffectual while the processor is working in the second context. As a result, an actively disrupting attacker can draw from his disruptions hardly any or no inferences about the secret data employed upon the computation.

Electively, there is carried out within the multiple computation at least one further countermeasure selected from the group of countermeasures comprising: randomized time delays; repeated computing of at least one block, i.e. interspersing of dummy executions of individual blocks.

A processor according to the invention is arranged with means for executing a method according to the invention, in particular with means for executing, within the multiple computation, blocks of the several, at least two, executions of the computation in interlaced order. Electively, the processor provides several mutually separate contexts, electively having multithreading ability, with different contexts being associated with different threads. Electively, each execution of the cryptographic computation runs e.g. in a dedicated context as a dedicated thread.

Hereinafter the invention will be explained more closely on the basis of exemplary embodiments and with reference to the drawing, in which there are shown:

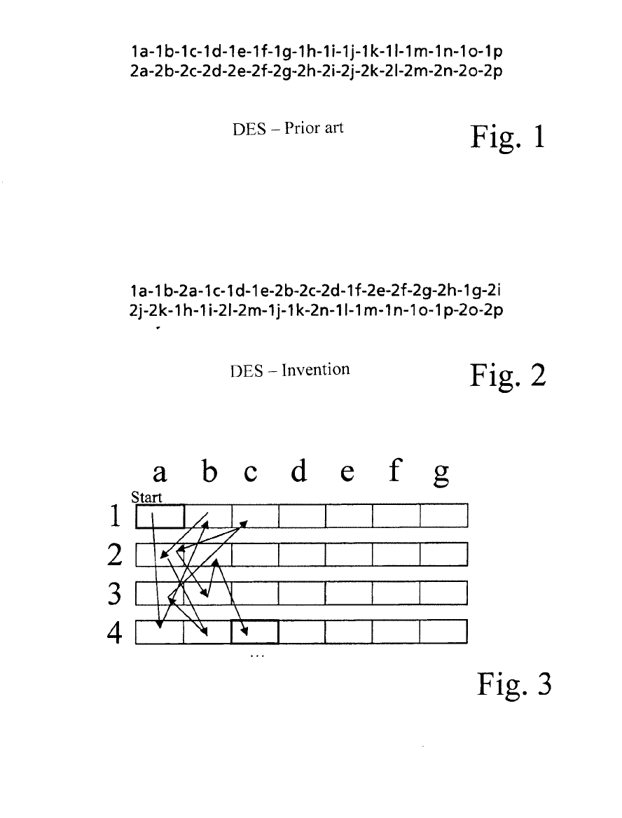

FIG. 1 a double computation of DES according to the prior art;

FIG. 2 a double computation of DES according to an embodiment of the invention;

FIG. 3 a quadruple computation of a non-cyclic crypto-algorithm, according to an embodiment of the invention.

FIG. 1 shows a schematic representation of the round sequence upon a double computation of DES (Data Encryption Standard) according to the prior art. DES comprises 16 rounds, designated in FIG. 1 as rounds a, b, . . . , o, p. The number 1 designates the first execution of DES, the number 2 designates the second execution of DES. According to FIG. 1, first all 16 rounds of the first execution of DES are executed, represented by the succession 1a-1b-1c-1d-1e-1f-1g-1h-1i-1j-1k-1l-1m-1n-1o-1p. Subsequently there is executed the succession 2a-2b-2c-2d-2e-2f-2g-2h-2i-2j-2k-2l-2m-2n-2o-2p, i.e. the complete second execution of the 16 rounds of DES.

FIG. 2 shows a schematic representation of the round sequence upon a double computation of DES (Data Encryption Standard) according to an embodiment of the invention. In contrast to the succession from FIG. 1, in the succession from FIG. 2 some rounds of the second execution of DES are scattered between the rounds of the first execution of DES. For example, the first two rounds 1a, 1b of the first execution of DES are executed, but then the first round 2a of the second execution of DES interspersed after the second round 1b of the first execution. There follow the third, fourth, fifth rounds 1c, 1d, 1e of the first execution, then the second, third, fourth rounds 2b, 2c, 2d of the second execution, etc. The order of rounds within an individual execution is maintained, i.e. the succession a-b-c-d-e-f . . . is not interchanged.

FIG. 3 shows a quadruple computation of a non-cyclic crypto-algorithm in a processor, according to a further embodiment of the invention.

The crypto-algorithm is executed four times, in accordance with the four lines 1, 2, 3, 4 in FIG. 3. The crypto-algorithm comprises seven blocks a, b, c, d, e, f, g, which are represented as identical boxes for simplicity's sake. In reality, each of the seven blocks a, b, c, d, e, f, g does not necessarily comprise the same computation steps, but normally even comprise different ones.

Each of the four executions 1, 2, 3, 4 is computed in a dedicated context 1, 2, 3, 4. The arrows in FIG. 3 indicate the switching between the four contexts 1, 2, 3, 4 when switching is effected between the four executions of the crypto-algorithm. The processor begins the quadruple computation in context 1 with block a of the first execution (“start”, box 1a). The processor switches from context 1 to context 4 (arrow from box 1a to box 4a) and computes block a of the fourth execution. The processor switches from context 4 to context 1 (arrow from box 4a to box 1b) and computes block b of the first execution. The processor switches from context 1 to context 2 (arrow from box 1b to box 2a) and computes block a of the second execution. The processor switches from context 2 to context 4 (arrow from box 2a to box 4b) and computes block b of the fourth execution. In FIG. 3 the processor, after a few further context switch-overs, is computing block c of the fourth execution in the fourth context. Thus, all blocks a-g of all four 1-4 executions are finally computed in interlaced order.

1-12. (canceled)

13. A method for executing a cryptographic computation comprising a plurality of blocks while employing secret data in a processor, said executing being protected against spying out of secret data, wherein to achieve a computational result of the computation, a multiple computation is executed in which the computation is executed several times, at least twice;
wherein within the multiple computation, blocks of the several, at least two, executions of the computation are executed in an interlaced order.

14. The method according to claim 13, wherein at least a first execution and a second execution of the computation are executed, and the blocks of the several, at least two, executions of the computation are executed in the interlaced order to the effect that there is at least one block of the first execution that is executed before a block of the second execution, and there is at least one further block of the first execution that is executed after a block of the second execution.

15. The method according to claim 13, wherein the computation provided is a cyclic cryptographic computation with several rounds and the blocks provided are rounds.

16. The method according to claim 13, wherein the computation provided is a non-cyclic cryptographic computation comprising a plurality of blocks.

17. The method according to claim 13, wherein a new interlaced order is fixed for each multiple computation.

18. The method according to claim 13, wherein the blocks are executed so as to be interlaced in a randomized manner.

19. The method according to claim 13, wherein each of the several executions of the computation that belong to an individual multiple computation is executed in a dedicated context of the processor, and wherein the blocks of the several executions of the computation are executed in the interlaced order by the processor switching between the contexts in accordance with the interlaced order.

20. The method according to claim 19, wherein there is provided as a first context a user mode of the processor and as a second context a system mode thereof

21. The method according to claim 19, wherein the processor switches between the contexts through a randomized time interval interrupt routine (timer interrupt) which respectively assigns to each context a time interval with a randomized length of computing time on the processor.

22. The method according to claim 19, wherein the secret data for computations in different contexts are held in different registers of the processor.

23. The method according to claim 13, wherein there is carried out within the multiple computation at least one further countermeasure selected from the group of countermeasures comprising: randomized time delays, repeated computing of at least one block.

24. A processor arranged with means for executing a method according to claim 13, including means for executing, within the multiple computation, blocks of the several, at least two, executions of the computation in interlaced order.
